(19) United States
(12) Patent Application Publication
(10) Pub. No.: US 2010/0237533 A1
(43) Pub. Date: Sep. 23, 2010

(54) Process for Producing Oriented Plastic Tube

(76) Inventors: Peter Glanville Chapman, New South Wales (AU); George Macovaz, New South Wales (AU); Joshua Stanley Gotham, New South Wales (AU); James Victor Henwood, New South Wales (AU)

Correspondence Address: GORDON & JACOBSON, P.C., 60 LONG RIDGE ROAD, SUITE 407, STAMFORD, CT, 06902, US

(21) Appl. No.: 12/738,502

(22) PCT Filed: Oct. 17, 2008
(86) PCT No.: PCT/AU08/01540

§ 371 Date: Apr. 16, 2010

(30) Foreign Application Priority Data
Oct. 17, 2007 (AU) 2007905683
Oct. 18, 2007 (AU) 2007905710

(51) Int. Cl. B29C 47/22; D01D 5/24

(52) U.S. Cl. 264/209.4; 425/460

(57) ABSTRACT

A start-up sequence for a continuous process for producing oriented plastic tube is disclosed. A variable diameter extruder (112) is started and is set to extrude a start-up diameter tube (220) which is significantly over the diameter of a pre-expansion tube diameter of the continuous process. The start-up diameter tube (220) is passed to and engaged by a first haul-off tractor (122). The start-up diameter tube (220) proceeds through to and over an upstream plug (128). The large, start-up diameter of the extruded tube (220) at start-up facilitates passage of the leading end of the start-up diameter tube (220) over a deflated, expandable portion (212) or a non-expandable portion (210) of a partly expandable plug (210, 212), depending on the arrangement of the expandable portion (212) and non-expandable portion (210). The tube is then reduced in diameter for the continuous process of diametral expansion and circumferential orientation to occur.

### BACKGROUND OF THE INVENTION

1. Field of the Invention

The present invention relates to the process and the apparatus for the manufacture of molecularly oriented plastic tubes, and in particular to the manufacture of tubes having a high degree of orientation in the axial or circumferential direction.

2. Description of the Art

Continuous processes for producing molecularly oriented plastics tube are known for example International Patent Application No. WO 90/02644 describes one such process for the manufacture of thermoplastics tubes. Thermoplastics such as un-plasticised polyvinyl chloride (PVC-U) may have a degree of orientation in the circumferential direction that improves properties such as resistance to hoop stresses, and renders the tubes particularly suitable for transmission of water under pressure. The process described in the referenced patent application comprises:
(i) extruding a tube of plastics material;
(ii) temperature conditioning the extruded tube to bring it to a temperature suitable for expansion;
(iii) diametrically expanding the tube by application of a relative internal pressure to the tube, such pressure being limited at its downstream end by a plug that is inflatable or otherwise expandable to maintain pressure within the expansion zone, and at its upstream end by a plug of fixed diameter; and
(iv) cooling the expanded tube to set the tube in its diametrically expanded configuration as a tube.

To pull a tube through such a process line a first haul-off tractor may be provided before the temperature conditioning zone and another haul-off tractor may be provided downstream of the expansion and cooling zones. Axial draw may be introduced into the product by running the downstream tractor at a higher haul-off speed than the first.

WO 04/089605 describes an improvement on the above-mentioned process and apparatus, in which the diameter of the tube pre-expansion is altered by a variable diameter calibrator to adjust and obtain an accurate circumferential draw, to allow compensation for changes in pipe class (i.e. wall thickness) and for improved ease of process line start up.

The contents of WO 90/02644 and WO 04/089605 are incorporated herein by reference.

### SUMMARY OF INVENTION

The present invention aims to provide an alternative process and apparatus for producing oriented plastic tube which overcomes or ameliorates the disadvantages of the prior art, or at least provides a useful choice.

In one form, the invention provides a continuous process for producing oriented plastic tube comprising a start-up sequence and then a continuous operating sequence, where the start-up sequence comprises performing the start-up sequence, including the steps of: extruding a tube to a start-up diameter tube greater than an operating pre-expansion diameter tube and then passing the extruded tube over an inactive diametrical expansion apparatus. Then reducing the diameter of the extruded tube produced to produce extruded tube of the smaller operating pre-expansion tube diameter and then performing the continuous operating sequence. The continuous operating sequence comprising the steps of: continuing extrusion of the tube to the operating pre-expansion tube diameter; temperature conditioning, diametrical expansion; and cooling.

Preferably a variable diameter extruder means may be used to produce the extruded tube. The variable diameter extruder means may include an extruder and a variable diameter die and sizing device. Either the extruder die or the sizing device may vary the extruded tube diameter without interrupting the continuous operation of the extruder.

Preferably the diametrical expansion step comprises application of an internal pressure to the tube within an expansion zone limited at its downstream end by a downstream plug in order to maintain pressure within the expansion zone. For the start-up sequence, the start-up diameter of the tube is sufficiently large to facilitate passage of the tube over the downstream plug. Optionally the downstream plug that may be at least partly expandable to maintain pressure within the expansion zone. During the start-up sequence the least partly expandable downstream plug is in an unexpanded state.

Preferably the at least partly expandable downstream plug has an expandable portion and a non-expandable portion; with the start-up diameter tube being sufficiently large to facilitate passage of the tube over the non-expandable portion.

In an alternative embodiment the diametrical expansion step may comprise the application of a solid or fixed style mandrel as a downstream plug within the diametrical expansion apparatus. In a further embodiment the diametrical expansion step comprises application of a mandrel within the diametrical expansion apparatus in lieu of the upstream and downstream plugs.

In a further form, the invention provides a process line for production of oriented plastic tube, comprising, a variable diameter extruder for:
producing a start-up diameter tube greater than an operating pre-expansion tube diameter during a start-up sequence for the process line, where the start-up diameter tube is passed over an expansion apparatus. The variable diameter extruder may also produce an operating pre-expansion diameter tube during a continuous operating sequence.
   During the continuous operating sequence the process line further includes:
temperature conditioning apparatus for bringing the operating diameter tube to a temperature suitable for expansion,
expansion apparatus for causing diametrical expansion of the operating diameter pre-expansion tube; and
cooling means for setting the tube in its diametrically expanded configuration.

Preferably the expansion apparatus includes a downstream plug that is at least partly expandable. The downstream plug may have an expandable portion and a non-expandable portion. Optionally one or more dimensions, such as diameter, of the non-expandable portion of the downstream plug and the start-up diameter tube are sufficient to facilitate passage of the start-up diameter tube over the non-expandable portion of the downstream plug.

In a further form the invention provides a continuous process for producing oriented plastic tube comprising the steps of producing an oriented tube having a first diameter tube by:
extrusion of a tube to an initial pre-expansion diameter;
temperature conditioning;
diametrical expansion to a first expanded tube diameter and then cooling
   Then varying one or more process parameters to produce an oriented tube product having a second expanded tube diameter by:
varying the diameter of the extruded tube to a second pre-expansion diameter tube while continuing extrusion of the tube;
temperature conditioning;
diametrical expansion to said second expanded tube diameter and cooling.

Preferably the extrusion step is carried out by a variable diameter extruder.

Further forms of the invention are as set out in the appended claims and as apparent from the description.

Further preferred embodiments of the invention will now be described with reference to the accompanying drawings.

### BRIEF DESCRIPTION OF THE DRAWINGS

FIG. 1 is a schematic representation of a continuous process line for production of oriented plastic tube, in accordance with an embodiment of the invention.

FIG. 2 is a schematic of a first start-up step of a start-up sequence operation in accordance with another embodiment of the process line of FIG. 1.

FIG. 3 is a schematic of a final start-up step of the start-up sequence operation in accordance with the embodiment of FIG. 2.

FIG. 4 is a schematic of a first start-up step of a start-up sequence operation of yet another embodiment of the process line of FIG. 1, in which a solid mandrel expansion apparatus is employed.

FIG. 5 is a schematic of a final start-up step of the start-up sequence operation in accordance with the process line embodiment of FIG. 4.

FIG. 6 is a schematic of a partly expandable plug in accordance with the invention.

FIG. 7 is a schematic of a continuous operating state of the partly expandable plug of FIG. 6.

FIG. 8 is a schematic of another alternate embodiment of the expandable plug.

FIG. 9 is a schematic of yet another embodiment of the partly expandable plug.

FIG. 10 is a schematic of continuous operating state of the partly expandable plug of FIG. 9.

### DETAILED DESCRIPTION OF THE PREFERRED EMBODIMENTS

### Continuous Process Line

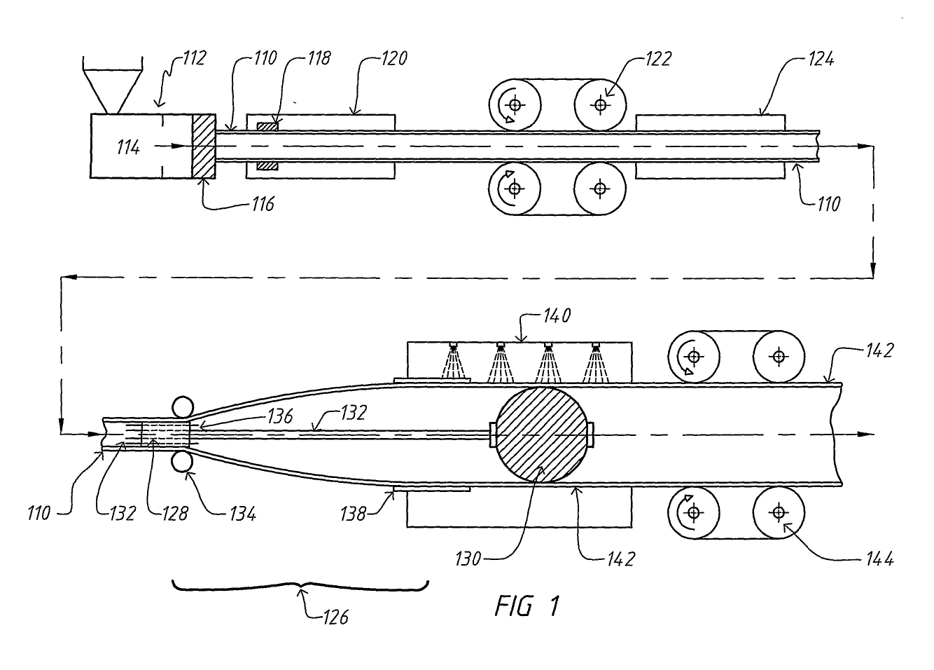

FIG. 1 schematically shows a process line for the continuous (i.e. on-line) production of oriented plastic tube, in which the tube undergoes extrusion, temperature conditioning, diametrical expansion and cooling steps as it progresses along the process line.

In FIG. 1 a plastic tube 110 may be produced continuously by a variable diameter extruder means 112 that is capable of varying the outside diameter and/or wall thickness of the extruded plastic tube 110 continuously, without interrupting the extrusion of the tube 110. The variable diameter extruder 112 may be capable of producing tube 110, by way of example, varying in diameter by a factor of x1 to x3. Optionally, the wall thickness of the extruded tube 110 may also be varied by the variable diameter extruder 112. An embodiment of a variable diameter extruder 112, may include an extruder 114 with a die and sizing device 116. The die and sizing device 116 providing a means to continuously vary the diameter of the extruded tube 110 without interrupting the extrusion process. Within the die and sizing device 116, the die and/or the sizing device may be capable of continuously varying the diameter of the extruded tube.

FIG. 1 further shows that the tube 110 from the variable diameter extruder means 112 is passed through a primary cooling spray tank 120. The primary cooling spray tank 120 may optionally contain a calibration or sizing means such as a sizing sleeve 118, which optionally may be in the form of a variable diameter sizing sleeve or a variable calibrator. Such optional sizing sleeves 118 may be used for fine, compensatory changes to the extruded tube or as an increased operating range variable calibrator to provide accurate control of the circumferential expansion ratio in the manner described in patent application WO 4/089605 “Method and Apparatus for Control of Plastics Tube Orientation Process”, the contents of which are incorporated herein by reference.

The tube 110 may be hauled from the variable diameter extruder 112 by a first haul-off tractor 122. The tube 110 then proceeds to a temperature conditioning zone 124, in which the tube 110 is contacted with a heat transfer medium such as water to attain a specific temperature profile across the tube 110 wall, at which the subsequent diametrical expansion of the tube 110 causes orientation of the polymer molecules principally in the circumferential direction. The tube 110 then enters an expansion zone 126, for diametrical expansion, between a pair of upstream 128 and downstream 130 plugs held inside the tube by a service tube 132 connected back through to the variable diameter extruder 112 to a suitable anchor such as the extruder die (not shown).

The first, upstream plug 128 relative to the direction of travel of the tube 110, is sized to fit tightly within the unexpanded/pre-expansion tube 110. A series of control wheels 134 surrounding the tube 110 circumference may push the tube 110 tightly onto the plug 134 so that there is a sufficient seal to maintain a fluid pressure in the expansion zone 126 of the tube 110. In an alternate embodiment, the control wheels 134 may be driven to dictate the velocity at which the tube 110 is fed into the expansion zone 126, for example as described in U.S. Pat. No. 6,296,804.

The downstream plug 130 is preferably expandable so that its diameter may be at least partially changed from the unexpanded state to an expanded state in order to start the continuous process line. The degree of expansion may be controlled to adjust the diameter of the expanded tube 142 produced in the expansion zone 126. An example of an expandable plug which expands by inflation may be as per that described in patent application number WO 95/17642 “Expandable Plug and Control Method”, the contents of which are incorporated herein by reference.

It will be appreciated that, while the preferred embodiment is described with reference to a process line using an expandable plug 130 for the diametrical expansion means in the expansion zone 126, a solid mandrel (of fixed or variable diameter types) or other diametrical expansion means may also be applied to such processes.

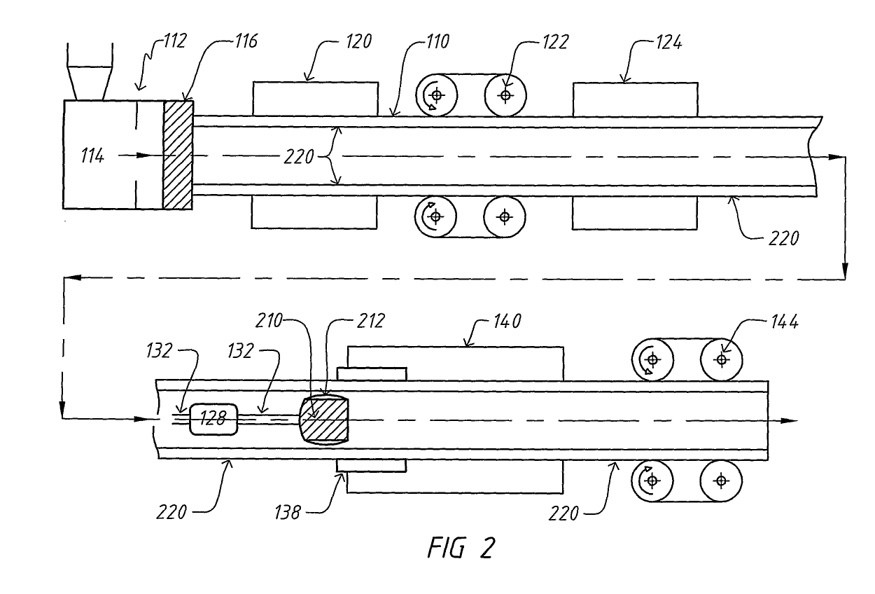

For example, whilst in the illustrated embodiment the downstream plug 130 is shown as a fully expandable plug, having an unexpanded diameter similar to that of the upstream plug 134, it may alternatively be partly expandable, comprising a fixed diameter (non-expandable) portion with a diameter greater than the upstream plug and further having an expandable (e.g. inflatable) portion providing the means for controlling the expansion of the tube. Examples of such a downstream plug 130 are described below with respect to FIGS. 2, 3 and 6 to 8.

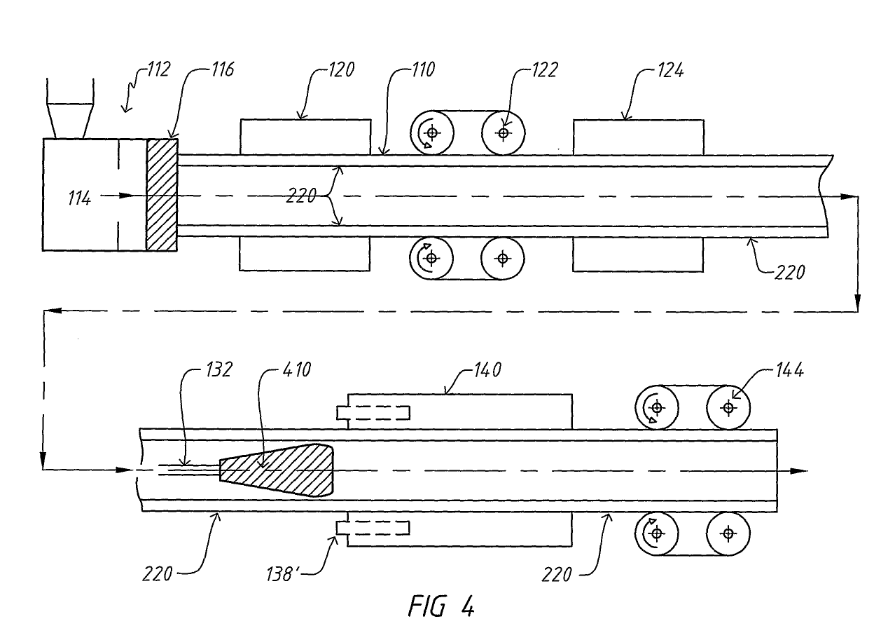

In a further alternative embodiment the expansion apparatus may comprise a fixed expansion mandrel with a sizing sleeve, such as that employed in the process as described in DE2357210 (Petzetakis), such an expansion apparatus is further described below with respect to FIG. 4.

In steady state, continuous operation of the process line of FIG. 1, the expandable plug 130 is expanded sufficiently to maintain a regulated expansion fluid pressure in the expansion zone 130. The regulation of the expansion fluid pressure may include allowing some of the expansion fluid to flow past the plug 130 which, optionally may serve to lubricate the plug 130 within the moving tube. The service tube 132 has a pair of internal tubes (not shown) which may be concentric tubes, one of which continues forward to carry inflation fluid, gas or liquid, to the downstream plug 130; and the other supplying expansion fluid, preferably hot, via the upstream plug 128, to enter the expansion zone 126 via outlets 136.

Between the two plugs 128, 130 the plastic tube 110 undergoes expansion in the radial direction due to the internal expansion fluid pressure, without external restraint. Towards the downstream end of the expansion zone 126, there is provided a sizing sleeve 138 or other sizing device and a cooling spray tank 140 for setting the final external diameter of the expanded tube product 142.

After setting the expanded tube 142 in the cooling spray tank 140 the expanded tube 142 product is acted on by a final haul-off tractor 144, which may be set at a higher speed than the first haul-off 122, and cutting equipment (not shown).

The average axial draw of the tube 110 over the whole process line is fixed by ratios of the first and final haul-off tractor 124, 144 speeds. Axial draw may be introduced both in the expansion zone 126 itself and in the pre-expansion zone 126 between the first haul-off 122 and the control wheels 134. Essentially no axial draw is introduced after the expansion zone 126 as the expanded tube 142 has been cooled.

The average wall thickness of the final oriented tube 142 may be additionally controlled by controlling the speed of the final haul-off tractor 144 either with or independent of the die and sizing device 116. Thus this embodiment allows the additional adjustment in tube 110 diameter to be made while operation of the process line continues, with only a brief interruption to production during the diameter transition rather than an interruption of several hours to shutdown the extruder 114.

In use, the illustrated process line and method allows for variation of the diameter of the tube exiting the variable diameter extruder 112 and entering the expansion zone 126, whilst the continuous process is running. The process may allow for large changes to be made in the circumferential expansion ratio of the finished oriented pipe—which is set by the ratio of the final to the extruded pre-expansion tube diameter—and/or large compensatory changes to be made to the extruded pre-expansion tube diameter to accommodate changes to the final tube 142 diameter and/or thickness, without the loss of production and cost of stopping the extruder 114.

Tube 110 diameter variations and irregularities greater than those typically acceptable in the manufacture of non-oriented tube may be allowable in the illustrated extrusion process, as some degree of out-of-round in the extruded tube pre-expansion 110 will be corrected as it passes through the expansion zone 126 and final sizing sleeve 138 calibration to the product 142 tube diameter.

### Start-Up for Process Line

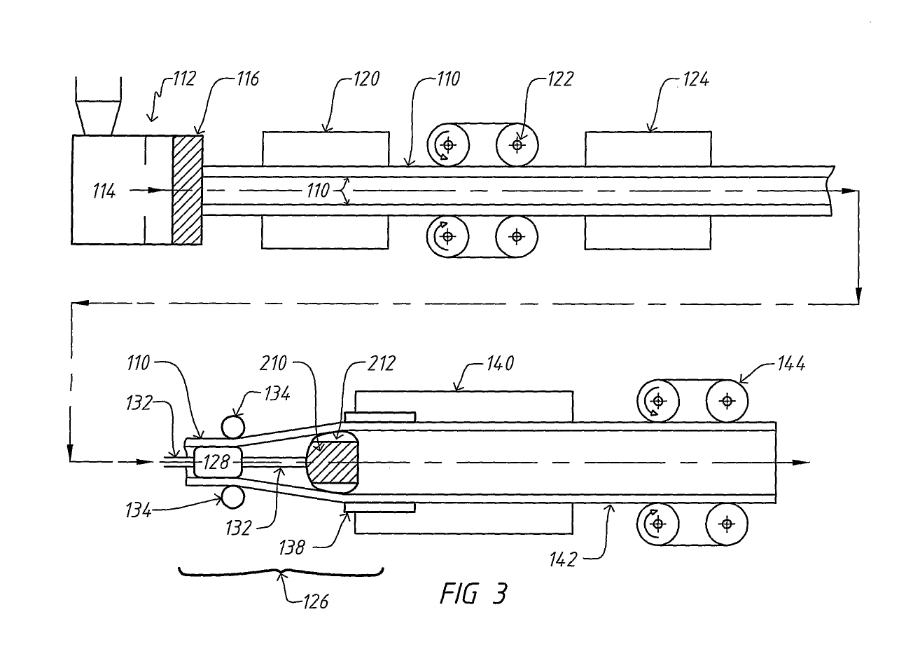

Further advantages of the invention in operation of the process are apparent from FIGS. 2 and 3, which schematically illustrate a start-up sequence for an alternate embodiment of the process line of FIG. 1.

In the embodiment of FIGS. 2 and 3, the inflatable, expandable downstream plug 130 of FIG. 1 is preferably replaced with a part-expandable plug comprising a non-expandable portion 210, which may be a fixed diameter core, with an inflatable or otherwise expandable portion 212. The part-expandable plug diameter may thus be expanded from a minimum diameter (FIG. 2) to a greater diameter (FIG. 3). In a preferred form, the expandable portion 212 comprises an inflatable plug portion of similar construction and operation to that described above for FIG. 1, hence allowing control of the expansion zone pressure via adjustment of the downstream plug pressure as in the embodiment of FIG. 1.

By the use of a part-expandable plug, the expansion ratio between the uninflated and inflated states of a plug may be substantially reduced, so that more durable construction techniques and materials may be used for an expandable plug. For example the inflatable, expandable portion 212 may be constructed in a similar but more robust manner to the inflatable plug described above for FIG. 1, WO 95/17642. In this example the expandable portion 212 may have a considerably thicker bladder wall encased within a sleeve of multiple layers of woven material. Where the woven material may be constructed in a highly laminar form with many strands, in a similar to manner to carbon fibre or aramide cloth used in composite materials.

This change in construction and materials potentially allows lower cost and/or longer downstream plug 130 life, while still allowing control of the plug and the expansion zone 126 by the principles employed for expandable plug process lines.

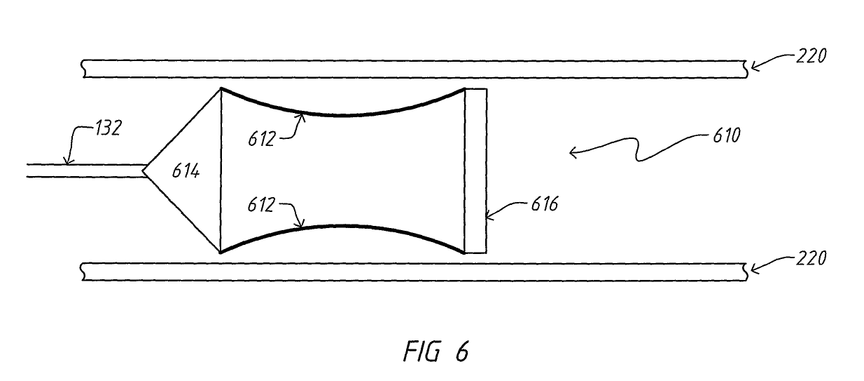

Further examples of alternate embodiments of a partly expandable plug are described below with respect to FIGS. 6 to 10.

FIG. 2 shows a first step in the start-up sequence of the process line, in which no or substantially no diametrical expansion is being carried out. The variable diameter extruder 112 is started and is set to extrude a start-up diameter tube 220 which is significantly over the diameter of the pre-expansion tube diameter 110. The start-up diameter tube 220 passes through the primary cooling tank 120 to be engaged by the first haul-off tractor 122.

The start-up diameter tube 220 proceeds through an inactive temperature conditioning zone 124 and then over the upstream plug 128, the start-up diameter tube 220 being of internal dimensions sufficient to pass over the upstream plug 128 entirely or with reduced frictional engagement.

The control wheels 134 (not shown) may be moved outwards of their operating positions to provide clearance for the start-up diameter tube 220 to pass.

The large, start-up diameter of the extruded tube 220 at start-up facilitates passage of the leading end of the start-up diameter tube 220 over the deflated, expandable portion 212 or the non-expandable portion 210 of the partly expandable plug; depending on the arrangement of the expandable portion and non-expandable portion 210, for example the embodiments described below with respect to FIGS. 6 to 10. The start-up diameter tube may pass over either portion of the partly expandable plug either without contact or with reduced contact. Any contact between the start-up diameter tube 220 and the downstream plug 210 in the start-up phase may be lubricated, for example by pre-waxing of the plug or by introducing a lubricating fluid to the contact region, to reduce wear on the plug 210, 212.

Once the leading end of the start-up diameter tube 220 passes through the inactive expansion zone 126, the final haul-off tractor 144 may be engaged to help pull the over diameter tube 220 along the process line.

Once the over diameter tube 220 has negotiated the process line the various process line apparatus and steps necessary for the continuous production of the oriented plastic tube may be commenced.

FIG. 3 shows the final start-up step from where the continuous process may be commenced. The intermediate steps to achieve the final start-up step comprise of the following. The variable diameter extruder 112 will be adjusted over a period of time to reduce the diameter of the extruded start-up diameter tube 220 to that of the pre-expansion tube 110 continuous operating diameter that is used for the continuous process (FIG. 3). The unexpanded/pre-expansion tube 110 passes through to the re-activated temperature condition zone 124 and the expansion zone 126.

Once the diameter of the tube 110 has been reduced sufficiently to contact the upstream plug 128, the control wheels 134 are returned to their operating positions against the tube 110 in order to maintain a seal against the upstream plug 128 as described above with reference to FIG. 1. Expansion fluid may then be introduced via the service tube 132 to inflate the inflatable portion 212 of the downstream plug 210, 212 and into the expansion zone 126 of the tube 110 to produce diametrical expansion of the tube in the expansion zone 126. Axial and circumferential draw are then applied to the tube 110 during the continuous process in order to produce the expanded tube product 142 of oriented tube.

It will be appreciated that, while the embodiment of the invention described in FIGS. 2 and 3 are described with reference to a process line using a part-fixed, part-expandable plug 210, 212, the benefits of the above embodiment will apply also to inflatable expander plugs such as that in FIG. 1 or to fixed mandrel type expansion means and processes or combinations of these arrangements, for example as per described with respect to FIGS. 6 to 10. In the case of a fixed mandrel-type expansion arrangement, the increased diameter of the extruded start-up diameter tube 220 at start-up may be insufficient to allow the tube to pass entirely over the mandrel without contact but the increased diameter allows instead reduced contact and consequent friction between the tube and the mandrel at start-up, thus reducing the force required to pass the tube over the mandrel prior to the downstream haul-off 144 being engaged with the tube.

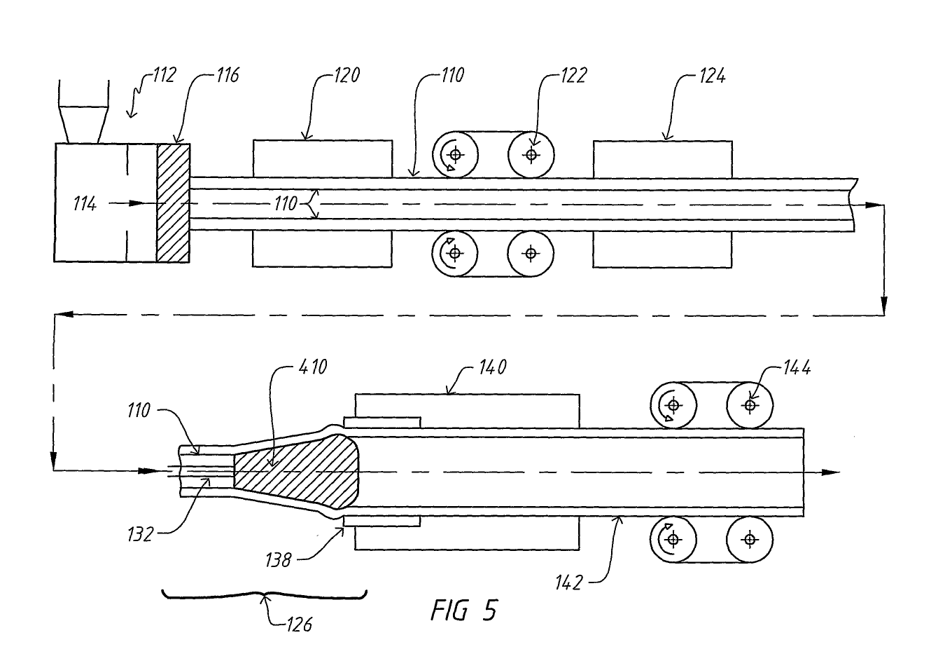

FIGS. 4 and 5 illustrate operation of the start-up sequence in relation to a process line employing solid or fixed style mandrel expansion apparatus. The general process line and start-up sequence is similar to that described above for FIGS. 2 and 3, and like reference numerals are used for like parts.

The primary differences are that the upstream plug 128 and downstream plug 210, 212 in FIGS. 2 and 3 are replaced by a solid or fixed style mandrel expansion means 410. An example of a suitable solid mandrel arrangement is a lubricated, generally conical mandrel such as that disclosed in DE2357210 (Petzetakis).

The mandrel 410 may be of slightly greater diameter than the finished diameter of the oriented tube 142, so that the tube diameter is drawn back down slightly to pass through the downstream final sizing sleeve 138, as can be seen in FIG. 5. The downstream final sizing sleeve 138 may be an adjustable calibrator/sizing sleeve, or formed in parts to allow passage of the start-up diameter tube 220, as will be described below.

As shown in FIG. 4, in the start-up sequence the variable diameter extruder 112 is set to produce a start-up diameter tube 220, of sufficient diameter to clear the mandrel 410, or at least to significantly reduce the contact between the tube 220 and the mandrel 410 during the start-up phase. The downstream or final sizing sleeve 138′ may be adjusted or moved to a position—shown in dashed lines—in which it permits the start-up diameter tube 220 to pass through.

As described above for FIGS. 2 and 3, the diameter of the extruded tube is then reduced to a smaller, pre-expansion operating diameter 110, the downstream final sizing sleeve 138 calibrator is moved into position to set the diameter of the finished tube 142 and the temperature conditioning and other process steps and apparatus commenced for the continuous orientation process.

As the temperature conditioned, extruded tube 110 passes over the mandrel 410, circumferential molecular orientation is induced, and the expanded diameter of the tube is drawn down by passing through the final sizing sleeve 138 set to the final diameter.

### Further Alternative Embodiments of the Expandable Downstream Plug

FIGS. 6 to 10 illustrate alternative embodiments of expandable downstream plugs.

FIG. 6 illustrates an alternative expandable plug 610 in longitudinal cross-section, for a section of the process line of FIG. 2, during the start-up sequence. The plug may have a sleeve of material 612 that may be flexible with a minimal capacity to stretch, if at all. When this inflatable downstream plug 610 is not in service a reduced pressure, with respect to that external of the plug 610, is applied by the service tube 132 to retract the flexible sleeve of material 612 within the cylindrical profile formed by the two end caps 614, 616. The region between the end caps 614, 616, within which the flexible sleeve 612 retracts into, may be considered analogous to the non-expandable portion 210 of the plug 210, 212 described with respect to FIG. 2.

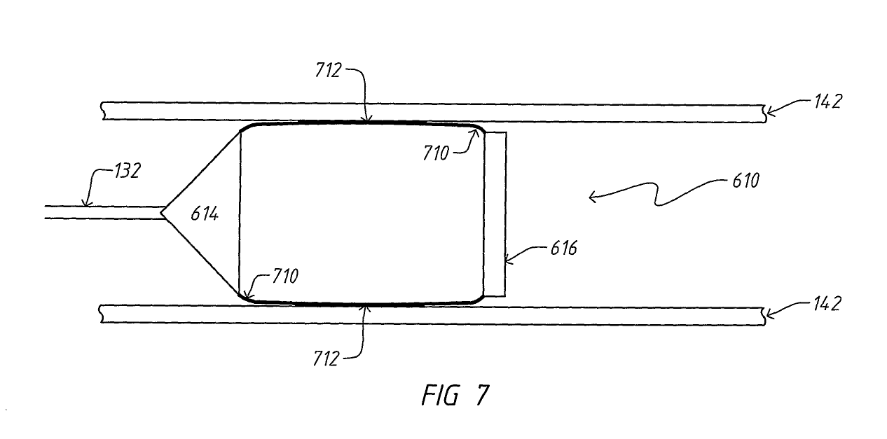

FIG. 7 illustrates the expandable plug 610 during the continuous process line operation. When it is desired to bring the downstream plug 610 into service an increased pressure may be applied via the service tube 132 so as to inflate the sleeve of material 612 so that it is positioned as 710, contacting the inner surface 712 of the expanded tube 142 as shown in FIG. 7. The increased pressure and the dimensions of the sleeve of material 612 being sufficient for the downstream plug 610 to serve as a seal by conforming to the inner surface 712 of the expanded tube product 142.

The sleeve of material 612 may be a considerably less elastic form of that described above with respect to WO 95/17642. The sleeve 612, 710 however may be flexible in order to be inflated. Alternatively the sleeve of material 612 may be of any other suitably durable, hard wearing material or composite of materials that a person skilled in the art may design or select.

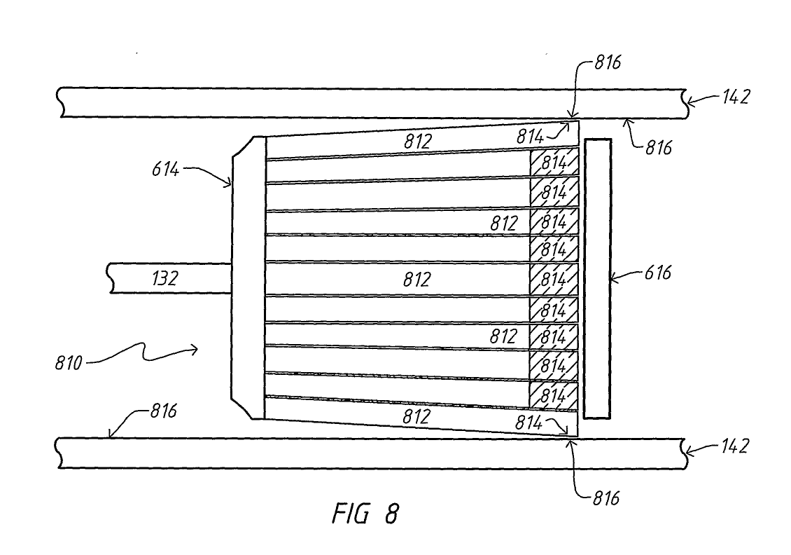

FIG. 8 illustrates yet another alternate embodiment of an expandable downstream plug 810 in use during the continuous operating sequence. The plug 810 features an arrangement of cylindrically mounted segments, leaves or petal plates 812 that are mounted between the two end caps 614, 616 of the plug 810. The petal plates 812 are pivotally mounted at the upstream end cap 614 and actuated from within the core of the downstream plug 810 such that a petal plate end 814 may be raised against the inner surface 816 of the expanded tube product 142 to form a seal. The actuation of the petal plates 814 may be by a hydraulic mechanism operated via the service tube 132 or by any means a person in skilled in the art of mechanical systems may select from or design.

The form of the petal plate end 814 is designed and formed such that the expanding downstream plug 810 performs as described above for the other downstream plugs described herein. For example the petal plate ends 814 may form a close fitting, overlapping arrangement when expanded against the inner surface 816 of the expanded tube 142 so that nil or minimal expansion fluid is released from the expansion zone 126. The petal plate ends 814 may be made of low friction materials such as PTFE, UHDPE or lubricated so that the expanded tube 142 passes easily over the petal plate ends 814.

In the start-up sequence the plug 810 may have its petal plates 812 retracted so that the petal plate ends 814 may be within the profile of the end caps 614, 616 in order to facilitate the passage of the start-up diameter tube 220 (not shown here) over the plug 810.

It will be readily appreciated that the above example embodiments of expandable downstream plugs and others may be employed in the continuous process line described with respect to FIG. 1 with the control methods typically associated with such a continuous process line using an expandable plug.

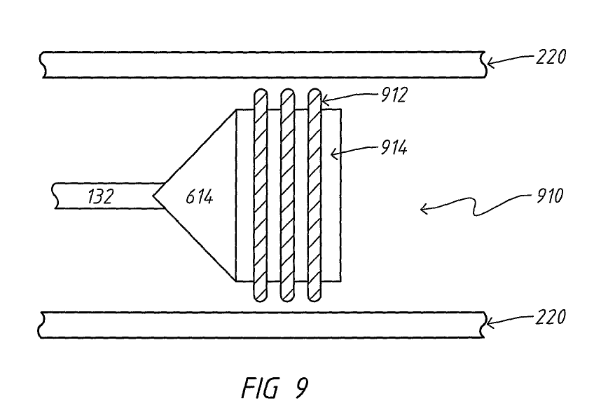

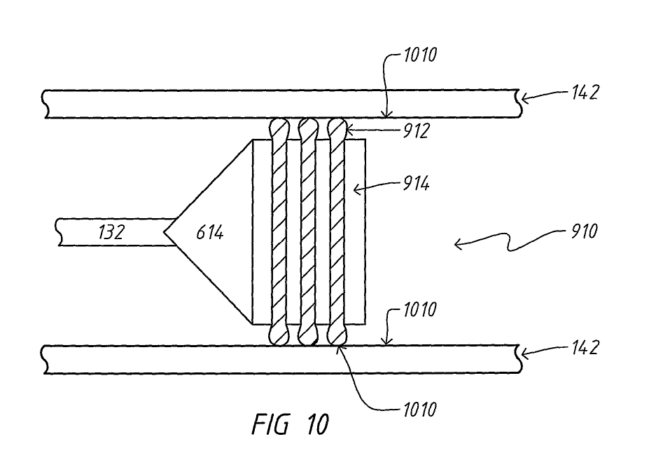

FIGS. 9 and 10 illustrate yet another embodiment of a partly expandable plug 910 applied to a section of the process line of FIGS. 2 and 3. Flexible o-ring like seals 912 may be mounted on a non-expandable core 914 to form a downstream plug. FIG. 9 illustrates the start-up diameter tube 220 being passed over the plug 910. Alternatively, the diameter of the start-up diameter tube 220 may be reduced (not shown) such that the leading end cap 614 of the plug 910 may be engaged in the manner of a solid or fixed mandrel by the leading edge of a reduced diameter start-up diameter tube. The reduced or partial diameter start-up diameter tube may then be guided or passed over the plug 910 via the end cap 614 also acting as a mandrel.

FIG. 10 illustrates the expandable plug 910 during the continuous process line operation. The flexible o-ring seals 912 may be compressed against an inner surface 1010 of the expanded tube product 142 so as to form a seal for the expansion fluid in the expansion zone 126 of the tube.

Although the invention has been herein shown and described in what is conceived to be the most practical and preferred embodiments, it is recognized that departures can be made within the scope of the invention, which is not to be limited to the details described herein but is to be accorded the full scope of the appended claims so as to embrace any and all equivalent assemblies, devices and apparatus.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises” where they appear.

It will further be understood that any reference herein to known prior art does not, unless the contrary indication appears, constitute an admission that such prior art is commonly known by those skilled in the art to which the invention relates.

1. A continuous process for producing oriented plastic tube including a start-up sequence followed by a continuous operating sequence, said process comprising:
performing the start-up sequence, the start-up sequence including:
(i) extruding a tube to a start-up diameter greater than an operating pre-expansion tube diameter;
(ii) passing the tube of start-up diameter over a diametrical expansion apparatus having an initial diameter, the start-up diameter of the tube greater than the initial diameter of the diametrical expansion device;
(iii) subsequently reducing the diameter of the tube of start-up diameter to the operating pre-expansion tube diameter; and then
performing the continuous operating sequence, the continuous operating sequence including:
(i) continuously extruding the tube to the operating pre-expansion tube diameter;
(ii) temperature conditioning the tube of operating pre-expansion tube diameter;
(iii) diametrically expanding the tube of operating pre-expansion tube diameter using the diametrical expansion device; and
(iv) cooling the diametrically expanded tube.

2. A process according to claim 1, wherein:
said extrusion of said tube to said start-up diameter is accomplished by a variable diameter extruder means.

3. A process according to claim 2, wherein:
said variable diameter extruder means includes an extruder and a variable diameter die and sizing device.

4. A process according to claim 2, wherein:
said variable diameter extruder means includes an extruder die and sizing device, said extruder die and said sizing device each capable of varying the diameter to which the tube is extruded.

5. A process according to claim 1, wherein:
diametrically expanding the tube during the continuous operating sequence includes applying an internal pressure to the tube within an expansion zone at a downstream end of the tube with a downstream plug, and the downstream plug maintains pressure within the expansion zone; and.

6. A process according to claim 5, wherein:
said downstream plug is at least partly expandable to maintain pressure within the expansion zone, and
said at least partly expandable downstream plug is in an unexpanded state during performance of said startup sequence.

7. A process according to claim 6, wherein:
said at least partly expandable downstream plug has an expandable portion and a non-expandable portion, and the start-up diameter is sufficiently large to facilitate passage of the tube over the non-expandable portion of said downstream plug.

8. A process according to claim 5, wherein:
diametrically expanding the tube includes applying a mandrel as a downstream plug within the diametrical expansion apparatus.

9. A process according to claim 1, wherein:
diametrically expanding the tube includes applying a mandrel within the diametrical expansion apparatus.

10. A process line for production of oriented plastic tube, comprising:
a variable diameter extruder for producing a tube having a start-up diameter greater than an operating pre-expansion tube diameter in order to pass the tube over an expansion apparatus having an initial diameter less than the start-up diameter and subsequently reduce the diameter of the tube to back to the operating pre-expansion diameter during a subsequent continuous operating sequence;
a temperature conditioning apparatus for bringing the tube of operating pre-expansion diameter to a temperature suitable for expansion;
an expansion apparatus for diametrically expanding the tube; and
a cooling means for setting the tube in a diametrically expanded configuration.

11. A process line according to claim 10, wherein:
said expansion apparatus includes a downstream plug that is at least partly expandable.

12. A process line according to claim 11, wherein:
said downstream plug has an expandable portion and a non-expandable portion.

13. A process line according to claim 12, wherein:
at least one dimension of at least one of the non-expandable portion of the downstream plug and the tube of start-up diameter is sufficient to facilitate passage of the tube of start-up diameter over the non-expandable portion of the downstream plug.

14. A continuous process for producing oriented plastic tube, comprising:
extruding a tube to an initial pre-expansion diameter;
temperature conditioning the tube of initial pre-expansion diameter;
diametrically expanding the tube of initial pre-expansion diameter to a first expanded tube diameter;
cooling the tube of first expanded tube diameter;
varying the diameter of the tube of first expanded tube diameter to a second pre-expansion diameter during continuous extrusion of the tube;
temperature conditioning the tube of second preexpansion diameter;
diametrically expanding the tube of second preexpansion diameter to a second expanded tube diameter; and
cooling the tube of second expanded tube diameter.

15. A process according to claim 14, wherein:
extrusion of said tube is accomplished with a variable diameter extruder.
